(19) United States
(12) Patent Application Publication
(10) Pub. No.: US 2015/0041399 A1
(43) Pub. Date: Feb. 12, 2015

(54) Ferrous Nanoparticle Oil Extraction

(71) Applicant: Duncan Mark Arthur Tennant, Redding, CT (US)

(72) Inventor: Duncan Mark Arthur Tennant, Redding, CT (US)

(73) Assignee: Duncan Mark Arthur Tennant, Redding, CT (US)

(21) Appl. No.: 13/939,024

(22) Filed: Aug. 8, 2013

(51) Int. Cl. C09K 8/58; E21B 43/16; B03C 1/00

(52) U.S. Cl. CPC C09K 8/58; B03C 1/002; E21B 43/16
USPC 210/695; 507/271; 428/402; 166/279

(57) ABSTRACT

Ferrous Nanoparticle Oil Extraction is the process of introducing ferrous nanoparticles coated in an oleophilic surfactant into oil reservoirs and implementing a magnetic force within the oil to supplement the traditional suctioning forces to extract oil. The nanoparticles, once in the oil, are allowed to disperse by Brownian motion and bind to the oil particles. The oil-nanoparticle solution is then magnetized and drawn out of the well. The magnetic force, originating at the mouth of the extraction pipe, supplements the traditional suctioning forces. Once collected, the oil-nanoparticle solution is passed through a high gradient magnetic separator, separating the oil from the nanoparticles. The nanoparticles are ready for reuse in the process of ferrous nanoparticle oil extraction.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

Ferrous Nanoparticle Oil Extraction is a processes designed for the extraction of oil from reservoirs within the ground. By utilizing magnetic Fe₃O₄ (Magnetite) nanoparticles coated in an oleophilic surfactant, oil can be drawn out from otherwise unreachable sections of the reservoir. In order to do so, in addition to the implementation of nanoparticles for oil extraction, the addition of a magnetic force to the reservoir will be required. The magnetic attraction that is created within the oil due to the addition of the nanoparticles and the magnetic force makes it possible to coax out oil from the expanses of the reservoir that had been previously unreachable. The nanoparticles, coated with the oleophilic surfactant, will bond to the oil particles. Once the nanoparticles have bonded to the oil particles, an oil-nanoparticle solution will be created. The addition of a magnetic force to the reservoir will magnetize the nanoparticles, which are bonded to the oil particles. This magnetic force will cause the oil-nanoparticle solution to be drawn to the source of the magnetic force, and also cause the oil-nanoparticle particles to be magnetically attracted to each other. This allows the oil to be extracted using magnetic force to supplement the traditional suction forces, creating a more efficient process. In addition, due to the magnetic attraction that exists between the numerous oil-nanoparticle particles, the solution can be used to draw more of the solution out from recesses of the reservoir that could not previously be extracted.

Previous advancements to the extraction of oil include the Carbon Dioxide-enhanced oil recovery method. This process entails pumping carbon dioxide gas into one end of the oil reservoir and pressurizing the reservoir so that the oil is forced out and into a second suctioning tube. The carbon dioxide process has numerous drawbacks.

The first of these drawbacks is that the carbon dioxide extraction process has a dependence on industrially supplied waste CO₂. This is problematic to the approach because current trends are that the CO₂ emissions that are permissible are subject to crackdowns in legislation. In short, it is unlikely that the amount of CO₂ required by the process to extract the oil will be able to be supplied in the long run.

A second advantage presented by the ferrous nanoparticle oil extraction approach is that the nanoparticles are fully reusable. Once the oil-nanoparticle solution has been removed from the well the nanoparticles can be reclaimed from the oil by an already existing magnetic process, high gradient magnetic separation, and then used again indefinitely. This is not the case for the carbon dioxide extraction process. The carbon dioxide can be recycled, but cannot continually be reused.

### BRIEF SUMMARY OF THE INVENTION

The process of Ferrous Nanoparticle Oil Extraction will insert Fe₃O₄ (magnetite) nanoparticles of size 10 nm in diameter coated with an oleophilic surfactant into the oil in the reservoir. Once the nanoparticles are inserted it is necessary to wait for them to disperse across the liquid by Brownian motion until they are equally distributed. The nanoparticles carry a magnetic charge, and will interact with the oil due to the oleophilic surfactant, causing the oil itself to become magnetic, through the bonding that occurs between the oil particles and the nanoparticles. The extraction pipe is then inserted into the well by traditional methods. A magnetic force is then introduced to the reservoir, triggering the oil-nanoparticle solution to be strongly attracted to the source of the magnetic force. The source of the magnetic force will be the mouth of the extraction pipe, and through the force of magnetic attraction initiated throughout the well the oil-nanoparticle solution will be attracted to the mouth of the extraction pipe. In addition to being drawn to the mouth of the extraction piping, the oil-nanoparticle particles are attracted to one another by the magnetic forces present in the oil-nanoparticle solution, creating a mechanism to coax oil out from within the confines of the reservoir. This allows oil that cannot be reached by the extraction piping to be removed, and can overcome the problem of having to abandon a well before all of the oil is removed, increasing efficiency. By combining the magnetic forces of attraction with the traditional suctioning methods used to siphon out the oil, it will be possible to remove significantly more oil from the well than was previously possible, including oil that could not be extracted with prior technology.

Once the oil-nanoparticle solution is extracted from the well, it is possible to separate the nanoparticles from the oil so that they may be reused. In order to do so the process of high gradient magnetic separation is used, removing the nanoparticles and leaving the oil in its original state. Once the oil is passed through a high gradient magnetic separator, the oil particles are separated from the ferrous nanoparticles, and the gathered nanoparticles may be reused in the process of ferrous nanoparticle oil extraction.

### BRIEF DESCRIPTION OF SEVERAL VIEWS OF THE DRAWING

FIG. 1: This drawing depicts a side view of the oil extraction piping (1) with a conical funneling head attached (2) and a magnet (3) with a smooth rounded tip (4) fitted centrally to both the extraction piping and the conical funneling head. For the purpose of the drawing both the conical funneling head and the rounded tip of the magnet are shown as line drawings and not 3D renderings to allow details and structure to be seen.

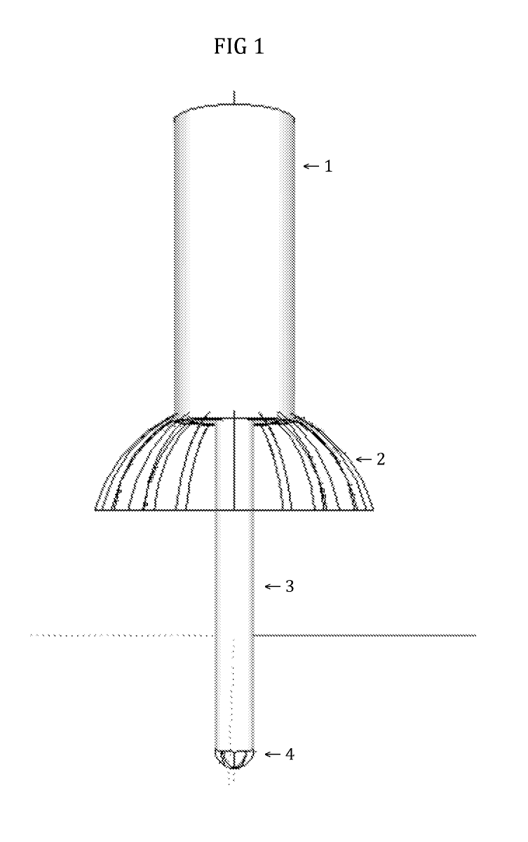

FIG. 2: This drawing illustrates a bottom view of the oil extraction piping (1) with the conical funneling head attached (2) and the magnet (3) fitted centrally.

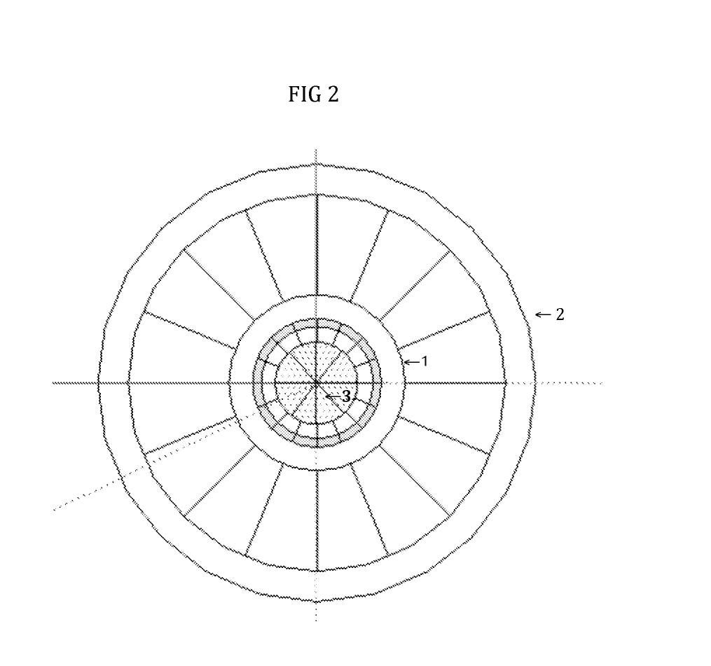

FIG. 3: This drawing shows an angled view from the bottom, allowing greater structure to be observed. The oil extraction piping (1) with the conical funneling head (2) attached and the magnet (3) with a rounded tip (4) fitted centrally.

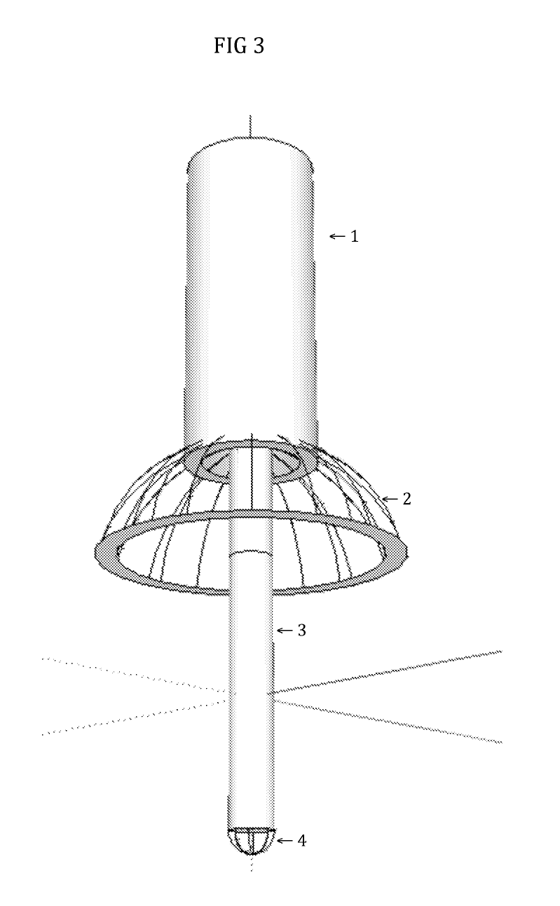

FIG. 4: This drawing demonstrates an angled view from the top, allowing greater structure to be observed. The oil extraction piping (1) with the conical funneling head (2) attached and the magnet (3) with a rounded tip (4) fitted centrally.

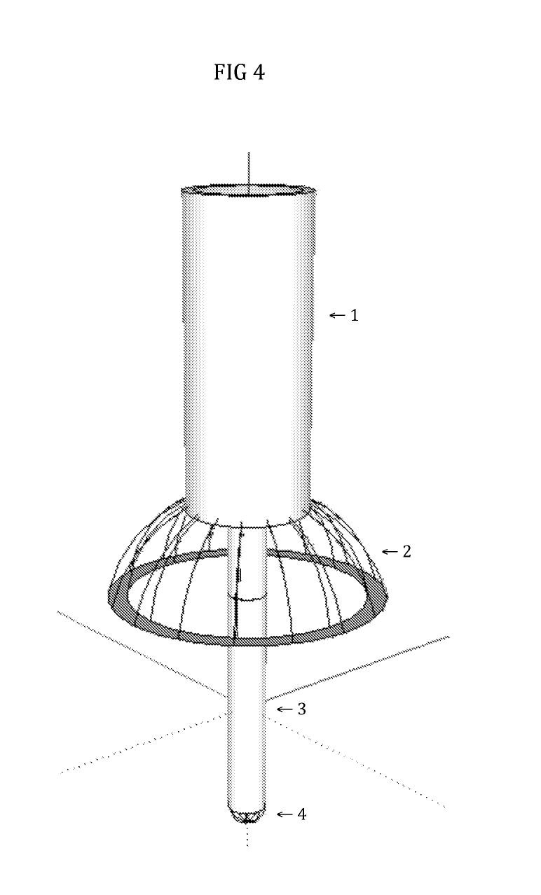

### DETAILED DESCRIPTION OF THE INVENTION

1. Formation of Ferrous Nanoparticles:

The ferrous nanoparticles utilized in this process should be created using a method that will allow for the size of the particles to be a diameter of 10 nm since this allows the particles to hold a single magnetic domain and serves to prevent agglomeration. A successful method of yielding such particles is to use the process of co-precipitation in which ferrous chloride and ferric chloride in solution with sodium hydroxide precipitate ferrous nanoparticles. These nanoparticles are then coated with an oleophilic stabilizing surfactant to further prevent against agglomeration, and also to allow for the particles to interact with, and be attracted to, the oil particles.

2. Inserting Nanoparticles into the Reservoir:

The ferrous nanoparticles of size 10 nm in diameter and coated in an oleophilic surfactant are then added to the oil reservoir. The nanoparticles disperse across the oil due to Brownian motion, and bond to the oil due to their oleophilic coating, creating an oil-nanoparticle solution.

3. Extraction of the Oil:

Traditional extraction processes using suction to draw oil into the mouth of the extraction piping are used, but are supplemented by magnetic forces. A strong magnetic force is introduced into the reservoir, and the source of the magnetic force is at the mouth of the extraction piping. The magnetization of the oil-nanoparticle solution draws the solution to the opening of the extraction pipe, where the magnetic force originates, but the now magnetized oil-nanoparticle solution also interacts with itself, pulling more distant oil-nanoparticle particles along towards the extraction pipe. The magnetic interaction between the oil-nanoparticle particles allows the oil itself to be used to make otherwise inaccessible oil accessible by drawing it out and into an area of the well where the forces of suction can act on the oil-nanoparticle solution, drawing it into the extraction piping.

4. Separation of the Oil-Nanoparticle Solution:

The separation of the nanoparticles from the oil is done by a high gradient magnetic separator. The oil-nanoparticle solution is passed through the high gradient magnetic separator, separating the oil from the nanoparticles. The oil is now in its original state, and ready to be processed. The collected nanoparticles may be reused in the process of ferrous nanoparticle oil extraction.

1. I claim the introduction of ferrous magnetite (Fe₃O₄) nanoparticles into oil reservoirs.

2. I claim that the ferrous nanoparticles described in claim one be of size 10 nm in diameter, to aid in the prevention of agglomeration, and to maintain a single magnetic domain.

3. I claim the nanoparticles described in claim two be coated in an oleophilic surfactant, allowing the nanoparticles to bond to the oil particles within the reservoir and further preventing agglomeration.

4. I claim the addition of a magnetic force to the oil reservoir.

5. I claim the magnetic force described in claim four supplements the traditional suction force used to extract oil from reservoirs within the ground.

6. I claim the magnetic force described in claim five originate at the mouth of the oil extraction piping.

7. I claim that after extraction the oil-nanoparticle solution pass through a high-gradient magnetic separator to separate the oil from the nanoparticles.

8. I claim that the nanoparticles separated from the oil in claim six be preserved, as they are fully reusable.
